(19) United States
(12) Patent Application Publication
(10) Pub. No.: US 2024/0144121 A1
(43) Pub. Date: May 2, 2024

(54) SYSTEM AND METHOD FOR CENTRALIZED OPERATIONS MANAGEMENT

(71) Applicant: Honeywell International Inc., Charlotte, NC (US)

(72) Inventors: Kalimulla KHAN, Bangalore (IN); Srihari JAYATHIRTHA, Phoenix, AZ (US); Wade LINDSEY, Canton, GA (US); Garrett RYSKO, Atlanta, GA (US)

(21) Appl. No.: 18/051,751

(22) Filed: Nov. 1, 2022

(51) Int. Cl. G06Q 10/06; G06Q 10/08

(52) U.S. Cl. CPC G06Q 10/063114; G06Q 10/06393; G06Q 10/06398; G06Q 10/08

(57) ABSTRACT

Disclosed are methods and systems for centralized operations management of a plurality of sites. For instance, a method may include providing a site management controller to each of a plurality of sites and configuring the site management controller to: obtain site data from each site in a respective data format; generate an abstract representation of the each set of site data using a respective algorithm for each site; process the abstract representations of the site data of each site; convert the processed abstract representations of the first site data to a concrete representations of the each site data in a common concrete data format; and export the concrete representation of the first site data to a user device for comparison and benchmarking.

### TECHNICAL FIELD

The present disclosure relates generally to methods and systems to optimize operations in workplaces such as warehouses, distribution centers, airport ground operations, and retail generally.

### BACKGROUND

Warehouses and distribution centers where employees are often engaged in a multitude of tasks can benefit from receiving real time and historical data from a variety of sources. Further, large businesses often have their operations distributed across several sites that may be spread across multiple geographical locations. Each site may be using different tools or software solutions to manage day to day operations, making it difficult to coordinate between sites. Any cross-site collaboration will need to be done manually and any best practices or insights are cumbersome to share between sites due to incompatibility of tools and/or solutions.

Therefore, overall operations may benefit from transmitting real time and historical data to optimize employee operations. Data patterns and trends can be determined from the received data, and the recipient can utilize the data patterns and trends to perform meaningful actions. In practice, optimization is often lacking since a significant amount of optimization benefits have remained unreachable. Moreover, external systems may collect data on which would be useful for an internal system to perform real-time monitoring. However, conventional techniques lack the ability to utilize external data because such data may be incompatible with an internal system. As a result, the internal system may not be able to provide a complete real-time context. Therefore, there is a need for an overarching system for collecting and analyzing real-time data from employees from multiple sites, and also for sharing critical data through a streamlined communication network, and for managers of multiple sites to be able to remotely monitor, schedule and execute tasks, and share insights related to important factors such as optimization, policy changes, and best practices seamlessly across their operations.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for abstracting data from disparate external systems to be used by an internal system.

In one aspect, a method for centralized operations management for a plurality of sites is provided, the method comprising: configuring a first site management controller of a first site of the plurality of sites, the first site including a plurality of first site tools controlled by the first site management controller to: provide first site application program interfaces (APIs) to the first site to obtain data from the plurality of first site tools; obtain first site data from the first site APIs; translate the first site data from the first site APIs to a specified API; and export the first site data to a user device; and configuring a second site management controller of a second site of the plurality of sites, the second site including a plurality of second site tools controlled by the second site management controller to: provide second site APIs to the second site to obtain data from the plurality of second site tools; obtain second site data from the second site APIs; translate the second site data from the second site APIs to the specified API; and export the second site data to the user device; wherein the first and second APIs are selected such that the first site data and the second site data are converted to a format compatible with the same specified API.

The method may further comprise configuring a third site management controller of a third site of the plurality of sites, the third site including a plurality of third site tools controlled by the third site management controller to: provide third site APIs to the third site to obtain data from the plurality of third site tools; obtain third site data from the third site APIs; translate the third site data from the third site APIs to the specified API; and export the third site data to the user device; wherein the third APIs are selected such that the third site data is converted to a format compatible with the same specified API as the first site data and the second site data.

In some aspects, the first site data includes operational metrics of the first site and the second site data includes operational metrics of the second site, and the method further comprises generating a first site score for the first site and a second site score for the second site, and further generating a site score for each of the plurality of sites, aggregating the site scores of the plurality of sites to provide a normalized benchmark score that is based on an average of the site scores of each of the plurality of sites. The user device may be configured to display the site score of each of the plurality of sites.

In another aspect, the operational metrics may include performance indicators based on operations, events, and/or tasks, wherein the operational metrics of each of the plurality of sites is measured based on a worker at each of the plurality of sites, a team at each of the plurality of sites, and/or an area of each of the plurality of sites.

In yet another aspect, a computer system for centralized operations management for a plurality of sites is disclosed, the computer system comprising: a memory having processor-readable instructions stored therein; and one or more processors configured to access the memory and execute the processor-readable instructions, which when executed by the one or more processors configures the one or more processors to perform a plurality of functions, including functions for: configuring a first site management controller of a first site of the plurality of sites, the first site including a plurality of first site tools controlled by the first site management controller to: provide first site application program interfaces (APIs) to the first site to obtain data from the plurality of first site tools; obtain first site data from the first site APIs; translate the first site data from the first site APIs to a specified API; and export the first site data to a user device; and configuring a second site management controller of a second site of the plurality of sites, the second site including a plurality of second site tools controlled by the second site management controller to: provide second site APIs to the second site to obtain data from the plurality of second site tools; obtain second site data from the second site APIs; translate the second site data from the second site APIs to the specified API; and export the second site data to the user device; wherein the first and second APIs are selected such that the first site data and the second site data are converted to a format compatible with the same specified API.

The system may further comprise functions for configuring a third site management controller of a third site of the plurality of sites, the third site including a plurality of third site tools controlled by the third site management controller to: provide third site APIs to the third site to obtain data from the plurality of third site tools; obtain third site data from the third site APIs; translate the third site data from the third site APIs to the specified API; and export the third site data to the user device; wherein the third APIs are selected such that the third site data is converted to a format compatible with the same specified API as the first site data and the second site data.

In another aspect, a non-transitory computer-readable medium containing instructions for centralized operations management for a plurality of sites, the instructions comprising: configuring a first site management controller of a first site of the plurality of sites, the first site including a plurality of first site tools controlled by the first site management controller to: provide first site application program interfaces (APIs) to the first site to obtain data from the plurality of first site tools; obtain first site data from the first site APIs; translate the first site data from the first site APIs to a specified API; and export the first site data to a user device; and configuring a second site management controller of a second site of the plurality of sites, the second site including a plurality of second site tools controlled by the second site management controller to: provide second site APIs to the second site to obtain data from the plurality of second site tools; obtain second site data from the second site APIs; translate the second site data from the second site APIs to the specified API; and export the second site data to the user device; wherein the first and second APIs are selected such that the first site data and the second site data are converted to a format compatible with the same specified API.

The instructions may further include configuring a third site management controller of a third site of the plurality of sites, the third site including a plurality of third site tools controlled by the third site management controller to: provide third site APIs to the third site to obtain data from the plurality of third site tools; obtain third site data from the third site APIs; translate the third site data from the third site APIs to the specified API; and export the third site data to the user device; wherein the third APIs are selected such that the third site data is converted to a format compatible with the same specified API as the first site data and the second site data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram illustrating an example environment implementing methods and systems of this disclosure, according to one or more embodiments.

FIG. 2 is a diagram of architecture of a connected warehouse system of this disclosure, according to one or more embodiments.

FIG. 3 is a flowchart illustrating a method for optimizing operations of a job site, according to one or more embodiments.

FIG. 4 depicts a process that utilizes a site management controller for generating specified APIs from the received external data.

FIG. 5 depicts a flowchart of an exemplary method for centralized operations management, according to one or more embodiments.

FIG. 6 depicts a flowchart of another exemplary method for centralized operations management, according to one or more embodiments.

FIG. 7 depicts a schematic block diagram of a framework of a platform of a connected warehouse system, according to one or more embodiments.

FIG. 8A depicts an exemplary diagram of a data flow of a connected warehouse, according to one or more embodiments.

FIG. 8B depicts an exemplary diagram of a data flow of a connected warehouse, according to one or more embodiments.

FIG. 9 depicts an example system that may execute techniques presented herein.

### DETAILED DESCRIPTION OF EMBODIMENTS

According to certain aspects of the disclosure, methods and systems are disclosed for systems and methods for providing standard interfaces that can be used for remote monitoring and operations of various sites. Warehouses and distribution centers where employees are often engaged in a multitude of tasks can benefit from receiving real time and historical data from a variety of sources. Further, large businesses have their operations distributed across several sites that may be spread across multiple geographical locations. Each site may be using different tools or software solutions to manage day to day operations, making it difficult to coordinate between sites. Any cross-site collaboration will need to be done manually and any best practices or insights cannot be shared between sites due to incompatibility of tools and/or solutions.

Therefore, overall operations may benefit from transmitting real time and historical data to optimize employee operations. Data patterns and trends can be determined from the received data, and the recipient can utilize the data patterns and trends to perform meaningful actions. In practice, optimization is often lacking since a significant amount of optimization benefits have remained unreachable. Moreover, external systems may collect data that would be useful for an internal system to preform real-time monitoring. However, conventional techniques lack the ability to utilize external data because such data may be incompatible with an internal system. As a result, the internal system may not be able to provide a complete real-time context. Therefore, there is a need for an overarching system for collecting and analyzing real-time data from employees from multiple sites, and also for sharing critical data through a streamlined communication network, and for managers of multiple sites to be able to remotely monitor, schedule and execute tasks, and share insights related to important factors such as optimization, policy changes, and best practices seamlessly across their operations.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of ±10% in a stated value. The term “exemplary” is used in the sense of “example” rather than “ideal.” As used herein, the singular forms “a,” “an,” and “the” include plural reference unless the context dictates otherwise.

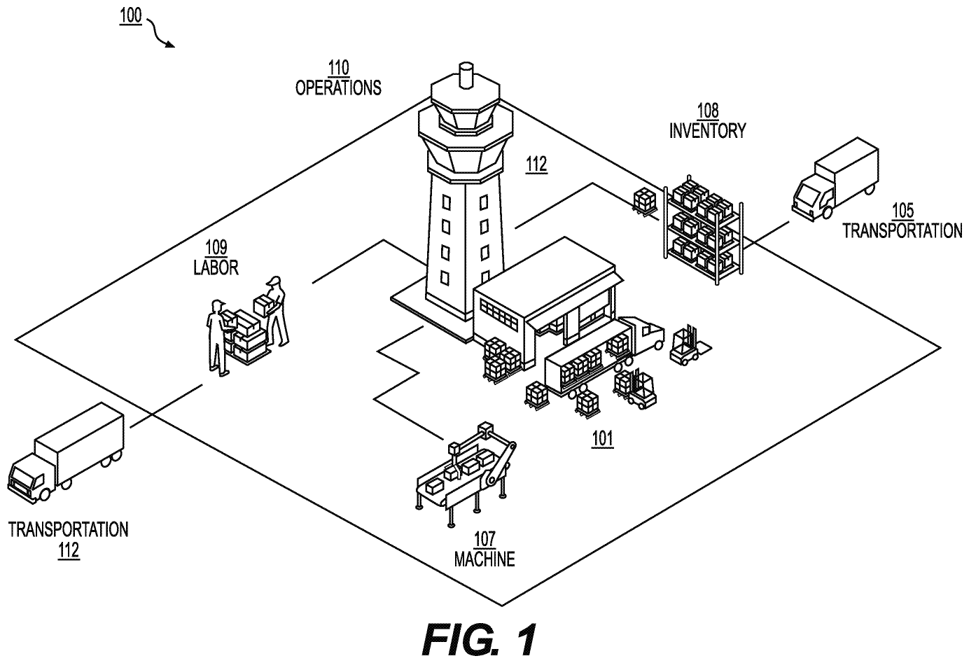

FIG. 1 illustrates an exemplary warehouse and/or distribution center environment 100 with certain components, including delivery transportation 105 (e.g., supply chain delivery truck) to load into inventory 108. An operational control tower 112 may monitor and/or otherwise control operations 110 within environment 100. Operations 110 can be performed and/or managed by labor 109. Operations 110 can include loading 101 and assembly machines 107. Once assembled, packaged, and otherwise processed for distribution, transportation 116 (e.g., a freight truck) can be loaded by labor 109 and depart for its subsequent destination. The environment 100 is configured to optimize worker performance by selectively scheduling and assigning tasks and worker equipment, as discussed more particularly below. The terms “worker” and “user” can be understood as a human, a non-human animal (e.g., a trained animal such as a dog) or any other asset that performs tasks at a job site (e.g., a robotic device).

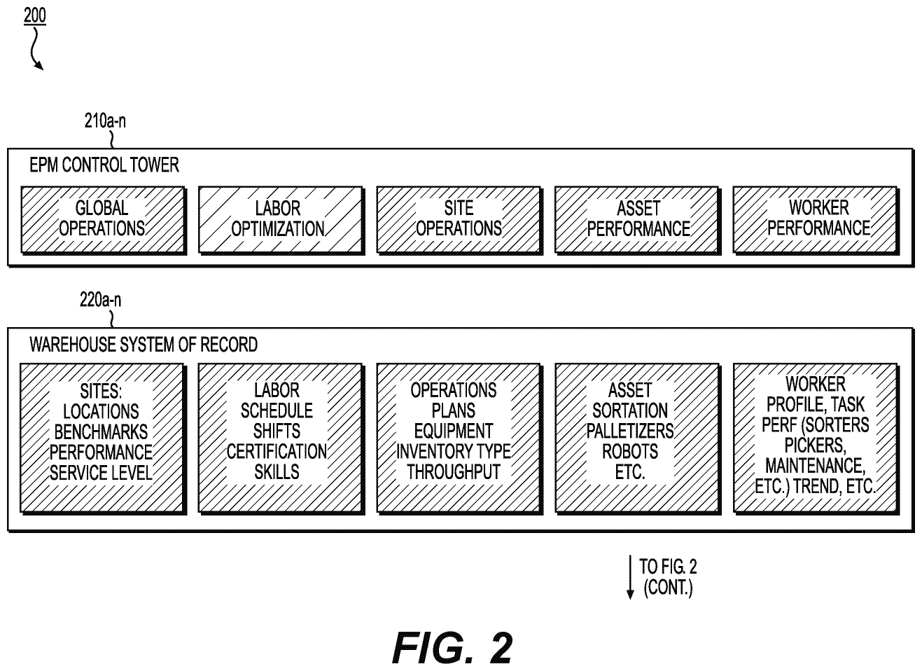

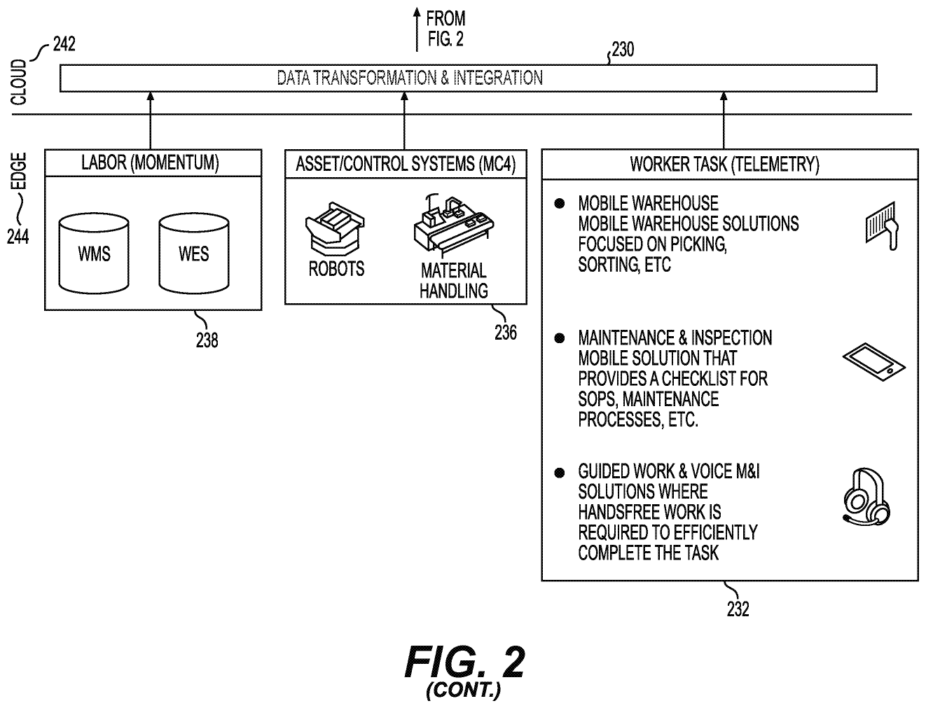

FIG. 2 illustrates a diagram of architecture associated with a connected warehouse system 200 of this disclosure. System 200 may include enterprise performance management (EPM) control tower 210a-n, including components and databases such as, but not limited to, global operations, labor optimization, site operations, asset performance, and worker performance. System 200 may also include a networked warehouse system of record 220a-n, including components and databases such as, but not limited to, sites (e.g., locations, benchmarks, performance service level, etc.), labor (e.g., schedule, shifts, certification, skills, etc.), operations (e.g., plans, equipment, inventory type, throughput, etc.), assets (e.g., sortation, palletizers, robots, etc.), and/or workers (e.g., trends, profiles, task performance such as sorters, pickers, maintenance works, etc.). EPM control tower 210a-n and networked warehouse system of record 220a-n can reside in a cloud based computing system 242 (e.g., a cloud computing network, one or more remote servers) and be communicatively coupled to data transformation and integration layer 230.

System 242 may be communicatively coupled to an edge computing system 244. System 244 can be an edge computing system or node with a dedicated unit onsite at the work site (e.g., factory, distribution center, warehouse, etc.). System 244 can be configured to process data and information from labor database 238, asset control systems 236 (e.g., components related to control of robots, material handling, etc.) and worker tasks database 232. Database 238 can include databases for warehouse management services (WMS) and warehouse execution systems (WES).

Database 232 can include one or more telemetry components operatively coupled to features of distribution center environment 100 to process and transmit control information, the incoming control information for consumption by one or more controllers of system 240 over a network. Database 232 can be configured for data validation and modification for incoming telemetry or attributes before saving to the database; copy telemetry or attributes from devices to related assets so the telemetry may be aggregated (e.g., data from multiple subsystems can be aggregated in related assets); create/update/clear alarms based on defined conditions; trigger actions based on edge life-cycle events (e.g., create alerts if device is online/offline); load additional data required for processing (e.g., load threshold value for a device that is defined in a user, device, and/or employee attribute); raise alarms/alerts when complex event occurs and use attributes of other entities inside email template; and/or consider user preferences during event processing. In some aspects, messages transmitted from database 232, such as triggers and/or alerts, can be configured for transmitting information to an end user (e.g., site lead, crew in the control tower, etc.) for optimization purposes. System 200 can also be configured to detect near accidents or other misses to build a trend model for early detection of anomalies before faults or malfunctions occur, thus increasing safety. In some aspects, the trend model can perform statistical analysis of worker trends including assigned tasks, event datasets to derive insights on worker performance considering the nature of work, skillset, criticality, labor intensity, etc. In some aspects, the trend model can classify data on a variety of key performance parameters to generate reports, dashboards, and insights that can be presented to users. In some aspects, the trend model can determine benchmarks based on statistics for type of task, skill set, geographical location, industry, and the like to enable performance-based assessment, incentives, and target setting for worker operations.

Database 232 can include mobile warehouse solutions focused on picking, sorting, and other such tasks. Database 232 can include maintenance and inspection components configured to provide one or more checklists with standard operating procedures (SOPs), maintenance processes, and the like. Database 232 can include guided work, as well as voice maintenance and inspection components where hands-free work may be required by employees to complete a task.

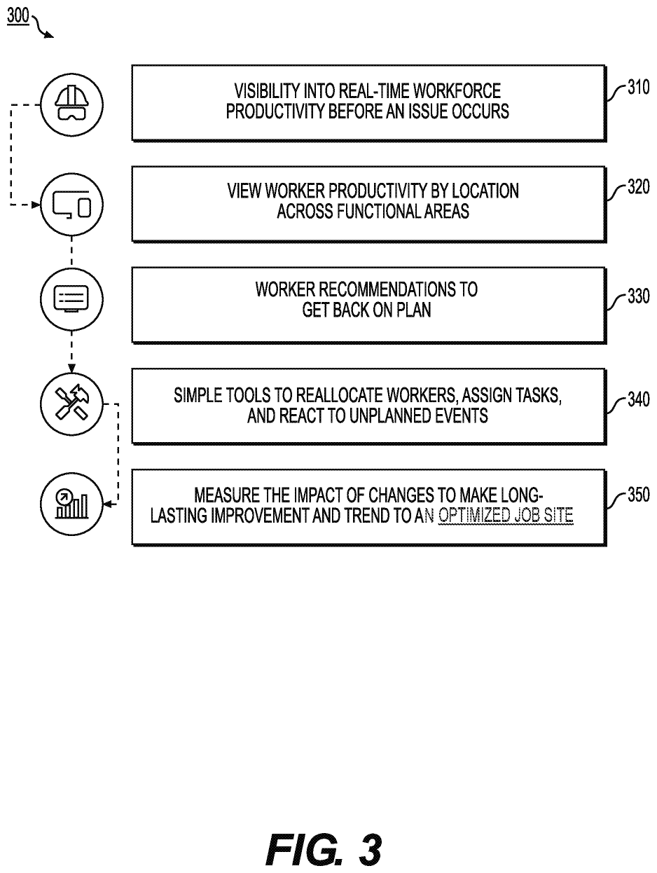

FIG. 3 is a flowchart illustrating a method 300 for optimizing operations of a job site, according to one or more embodiments. In step 310, the method may include providing visibility into real-time workforce productivity before an issue occurs. In step 320, the method may include viewing worker productivity by location across functional areas. In step 330, the method may include providing worker recommendations to return to a worker plan. In step 340, the method may include providing tools to reallocate workers, assignment tasks, and/or react to unplanned events. The reallocation of workers or tasks may be in response to identifying a surplus of idle workers on one task or in one space, and a lack of available workers on another task or in another space. In step 350, the method may include measuring the impact of changes to make persistent improvements and trend to an optimized job site.

Although FIG. 3 shows example blocks of exemplary method 300, in some implementations, the exemplary method 300 may include additional blocks, fewer blocks, different blocks, or differently arranged blocks than those depicted in FIG. 3. Additionally, or alternatively, two or more of the blocks of the exemplary method 300 may be performed in parallel.

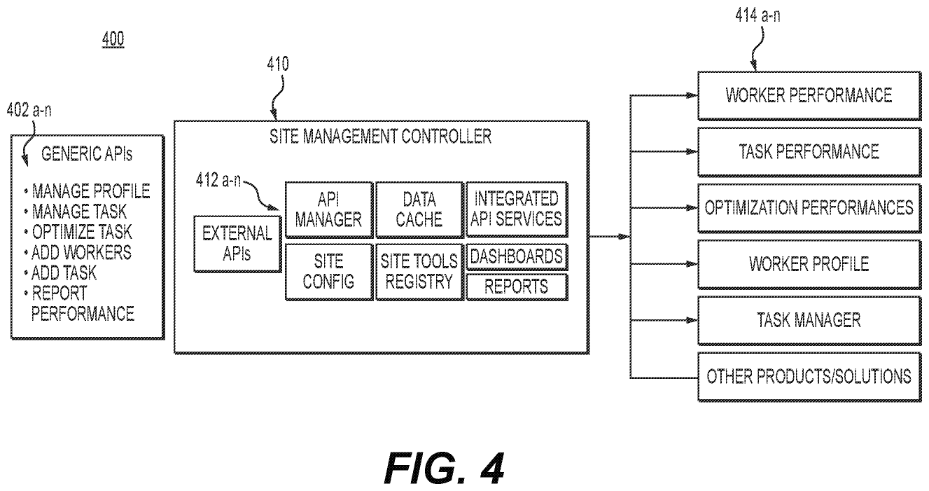

FIG. 4 depicts a process 400 for generating specified concrete APIs 414a-n from the received external data in the general APIs using a site management controller 410.

The site management controller 410 provides an integration and control of site-specific tools/solutions for managing the day-to-day activities at a plurality of sites, and allows for a central control tower approach to monitoring and managing each site regardless of variability in Labor Management Systems (LMS) and the types of APIs used at each site, thus advancing the objectives described in FIG. 3 in optimizing a plurality of job sites in an integrated manner. Each site may have a different set of tools that include their own sets of interfaces for mobile and/or desktop applications. Each of the tool specific interfaces or APIs are abstracted at the site management controller 410 by providing a general set of APIs for site level operations as described below.

Each site may use its own set of general APIs 402a-n to perform operational processes such as managing profiles for workers, teams, supervisors, etc., managing tasks, optimizing tasks, adding workers and tasks to a site schedule, and/or reporting performance metrics and scores. The site management controller 410 receives this information and translates it to useful information that can be abstracted and standardized across all sites. The site management controller 410 handles all the necessary translations from the general APIs to the concrete APIs based on the site specific tool/solutions deployed. The site management controller 410 can include a number of integrated data support systems 412a-n such as a database of the external APIs, an API manager, a site configuration tool, a site tools registry, a cache for data, integrated API services, and integrated generated data, such as reports and dashboards, to support general reporting and dashboard capabilities for all sites. The data formatting and site-specific capability of supporting APIs is handled by providing appropriate response to the client sites invoking the APIs.

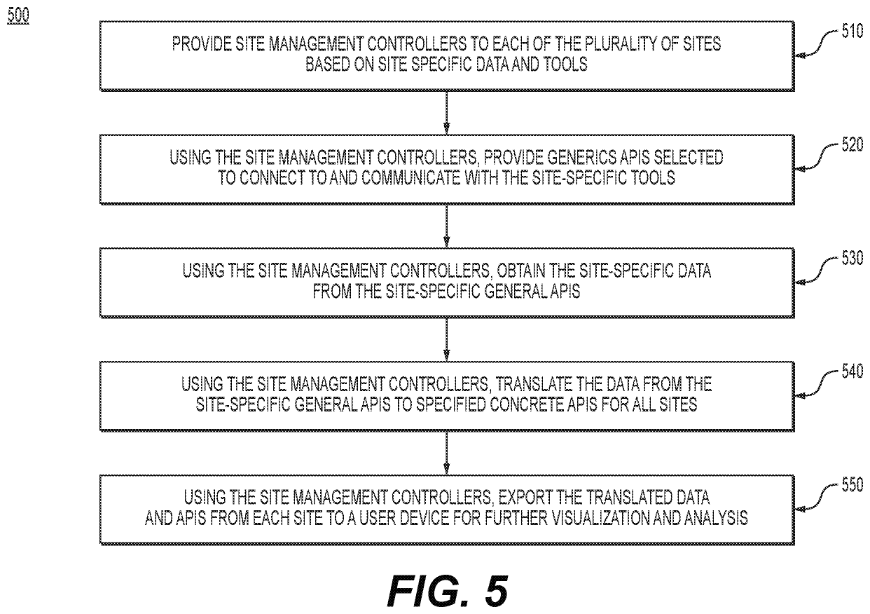

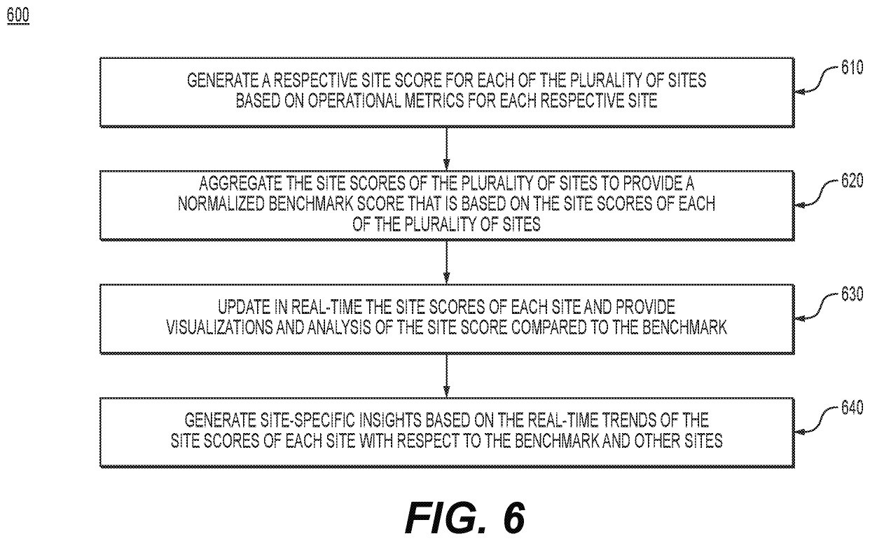

The site controller manager 410 produces concrete APIs 414a-n that may include reports or dashboards relaying information regarding worker performance, task performance, optimization services, worker profiles, task managers and calendars, and other products and/or solutions relevant to the specific sites. The site controller manager 410 is able to aggregate the quantified and qualified KPIs governing operations, events and tasks for a particular worker, team, area, site, geographic region, and/or company into an overall normalized numerical score which may be tracked over time and locations to standardize operations across portfolios. A particular site score may be a normalized score generated by the site management controller 410 and is comparable with other sites for benchmarking and for display on reports and/or dashboards. These processes and more are described in more detail in FIGS. 5 and 6 below.

The site management controller 410 provides an overarching software solution that cuts across various site-specific tools/solutions and abstracts the underlying variability within the sites. This solution provides standard interfaces that can be used for remote monitoring and operations of various sites. Any commands or instructions for operational changes can be simultaneously executed across sites by interacting with a central operations station via a specified user device. This solution provides a bird's eye view across the sites in the portfolio for remote monitoring, execution and gathering of general insights on site specific, region-specific operational metrics, such as operations score, event score, and task score, among other potential scores and metrics, that may be used for improving operational efficiency of the complete portfolio.

FIG. 5 depicts a flowchart of an exemplary method for centralized operations management, according to one or more embodiments. In step 510, site management controllers 410 (see FIG. 4) are provided to each of a plurality of operational sites (see, e.g., FIG. 1) that form part of the network of sites to be monitored and controlled. The sites may all be of the same type (e.g., warehouses, medical facilities, airports, etc.), or may be of varying types. Each site may have its own native or general APIs (402a-n) and data formats, such that the site management controller 410 for each site is configured to have components to communicate with the APIs of a specific site. These APIs are based on the specific tools of the site, which may include one or more user interface systems for smart worker performance scoring and evaluation of the job site, whereby information from sensors and/or connected worker computing devices may provide dynamic data about job performance (e.g., productivity of worker(s), task productivity, production productivity, etc.) to the user interface systems. The site tools registry is provided on the site management controller to provide information about the site-specific tools, and the site configuration tool provides the connections to the tools to provide general APIs for obtaining data from the site-specific tools in step 520. API manager provides a database of the general APIs from which the site-specific general API is selected and applied to the site in question.

Step 530 may comprise obtaining data from the site-specific tools and APIs via any desired modality, such as wired connection, wireless connection, e.g., via near field communication, Bluetooth, Wi-Fi, and the like. Among the integrated data tools 412a-n, the external APIs, data cache, site tools registry and site configuration tool support in the obtaining of data in step 530. The external APIs provide the general APIs of the site and provide for data management, while the site configuration tool provided the parameters of the site, such as communicating the type of site (e.g., warehouse, medical facility, airport, etc.), so that the site management controller may be configured to obtain and format data relevant to the site, such as types and numbers of workers, shift schedules, and inventory considerations that are distinct to the site. The data cache contains on-demand data ready for display and visualization that is pre-aggregated for the site. The data may include but is not limited to work orders, labor, training data, prediction results, events, fault, costs, reasons, status, tasks, events, and any other information that may be pertinent to the optimization of the controls and operations of a job site. At step 540, the site-specific data that was obtained via the site-specific general API is translated using a site-specific algorithm into a concrete API that is generalized and common to all sites. The algorithm for translating from the general API to the concrete API may be stored in the API manager and correlated with the general API therein, or may be based on a machine-learning model, an AI model or the like. After the concrete APIs are generated, they may be exported at step 550 to a user device for further visualization and analysis via any desired modality, such as wired connection, wireless connection, e.g., via near field communication, Bluetooth, Wi-Fi, and the like. The user device may be any of a mobile device, desktop device, or any other device that may be configured to connect to the concrete API. The concrete API includes reports and dashboards that may be generated at the site management controller and may include real-time models that reflect a variety of insights as described throughout this disclosure, such as metrics regarding worker performance, task performance, optimization services, worker profiles, task managers, and other products and solutions. The reports and dashboards may also be directed to trend models of the same metrics. In some aspects, the trend models can perform statistical analysis of worker trends including assigned tasks, event datasets to derive insights on worker performance considering the nature of work, skillset, criticality, labor intensity, etc. In some aspects, the trend model can classify data on a variety of key performance parameters to generate reports, dashboards, and insights that can be presented to users. In some aspects, the trend model can determine benchmarks based on statistics for type of task, skill set, geographical location, industry, and the like to enable performance-based assessment, incentives, and target setting for worker operations.

Although FIG. 5 shows example blocks of exemplary method 500, in some implementations, the exemplary method 500 may include additional blocks, fewer blocks, different blocks, or differently arranged blocks than those depicted in FIG. 5. Additionally, or alternatively, two or more of the blocks of the exemplary method 500 may be performed in parallel.

FIG. 6 depicts a flowchart of another exemplary method for centralized operations management, according to one or more embodiments, depicting an exemplary use of the data generated from the concrete APIs in FIG. 5. One such use for the concrete APIs which are normalized across a set of sites is that a site score may be generated for each of the plurality of sites that is based on operational metrics that are common to all of the sites involved. Each of the plurality of sites may have had different site-specific data formats and user interfaces for data input and output. However, upon providing the site management controllers 410 to each site as described in FIGS. 4 and 5 above, data from each site is now available in a common concrete API and is available to the relevant user on their user device. The relevant user may be a supervisor or manager or any other party with access and interest in the control, optimization and analysis of the performance of the plurality of sites.

One use for the data from the concrete APIs, as shown in step 610, is to generate a “site score” for each of the plurality of sites based on the operational metrics for each respective site. The operational metrics are site specific and may be related to worker performance at the site, task performance at the site, inventory performance at the site, energy usage at the site, or any combination thereof and with other metrics that may be of interest or value to be added as well. The metrics may include information from sensors and/or connected worker computing devices may provide dynamic data about job performance (e.g., productivity of worker(s), task productivity, production productivity, etc.), a processor and database(s) for receiving and processing the dynamic data, and having a program that aggregates and analyzes the dynamic data for one or more categories of the one or more worker performance. The data analysis may determine performance scores for each of the one or more performance categories, and calculate an overall worker performance score.

The site score for each category of this disclosure may be displayed on a dashboard and/or related scorecards. In some aspects, one or more functions are used to calculate scores (e.g., assigning a coefficient factor to values of categories such as time on task, time between tasks, number of tasks completed, idle state, etc.). The coefficient factor may be determined from a comparison value based on some predetermined standard and/or worker performance historical data of the one or more categories. Any of the herein disclosed dashboards and related user interfaces may present worker performance scores and related details of the dynamic data for detecting and solving worker performance issues (e.g., recommended corrective actions) without changing the dashboard or the monitor.

The site scores of this disclosure can include numerous scores and sub-scores, including performance scores, environmental scores related to the job site and/or areas of a job site (e.g., utility consumption, carbon footprint, emissions, etc.), health scores, safety scores, maintenance scores, job site asset scores, happiness scores, etc. Such scores are also advantageous for use in using trained machine learning models to predict performance impacts depending on trends of all such scores of this disclosure.

In step 620, the site scores of this disclosure may be aggregated and normalized to provide a benchmark score to which the site scores of all of the sites may be compared. Similarly, the numerous scores and sub-scores, including performance scores, environmental scores related to the job site and/or areas of a job site (e.g., utility consumption, carbon footprint, emissions, etc.), health scores, safety scores, maintenance scores, job site asset scores, happiness scores, etc. may also similarly be aggregated and normalized to provide benchmarks. The benchmark score may be selected as the average of all sites, the highest of all sites, the median of all sites, the mean of all sites, may be adjusted by an operator based on other factors, or may be determined by any other standard for operational expectation.

At step 630, visualization and analysis is provided for each site with respect to the benchmark and is updated continuously in real-time. In the context of this disclosure, continuously is used to mean repeated automatically at intervals that may be anywhere from one second, to one day, to one week, one month, etc., and any interval in between as desired and determined by the relevant users. In real-time is determined to be as close as technologically possible to immediate results. The visualization and analysis may include color-coded representations of the data, such as red for site scores that do not meet the benchmark, and green for site scores at or above the benchmark. They may also include numerically adjusting the site scores based on the benchmark, e.g., fixing the benchmark to a specified number such as 100, so that for quick reference a score under 100 is easily identifiable as falling below the expectations set by the benchmark and a score above 100 is easily identifiable as exceeding the expectations set by the benchmark. At step 640, the concrete APIs may generate insights based on the data gathered from the concrete APIs automatically without the intervention of users or operators. These insights may include changes in workforce scheduling, changes in inventory ordering, or any other business optimization techniques that may be determined by the system. This may be done using a machine learning model to effectively process, analyze, and classify the data provided by the concrete APIs. The model may be a trained machine learning system having been trained using a learned set of parameters to predict one or more learned performance parameters of the site. Learned parameters can include but are not limited to predictive asset maintenance, asset health management, asset maintenance optimization, worker downtime reports, instrument asset management, and worker performance. The model may be trained with a regression loss (e.g., mean squared error loss, Huber loss, etc.) and for binary index values it may be trained with a classification loss (e.g., hinge, log loss, etc.). Machine learning systems that may be trained include, but are not limited to convolutional neural network (CNN) trained directly with the appropriate loss function, CNN with layers with the appropriate loss function, capsule network with the appropriate loss function, Transformer network with the appropriate loss function, Multiple instance learning with a CNN (for a binary resistance index value), multiple instance regression with a CNN (for a continuous resistance index value), etc.

Although FIG. 6 shows example blocks of exemplary method 500, in some implementations, the exemplary method 500 may include additional blocks, fewer blocks, different blocks, or differently arranged blocks than those depicted in FIG. 5. Additionally, or alternatively, two or more of the blocks of the exemplary method 500 may be performed in parallel.

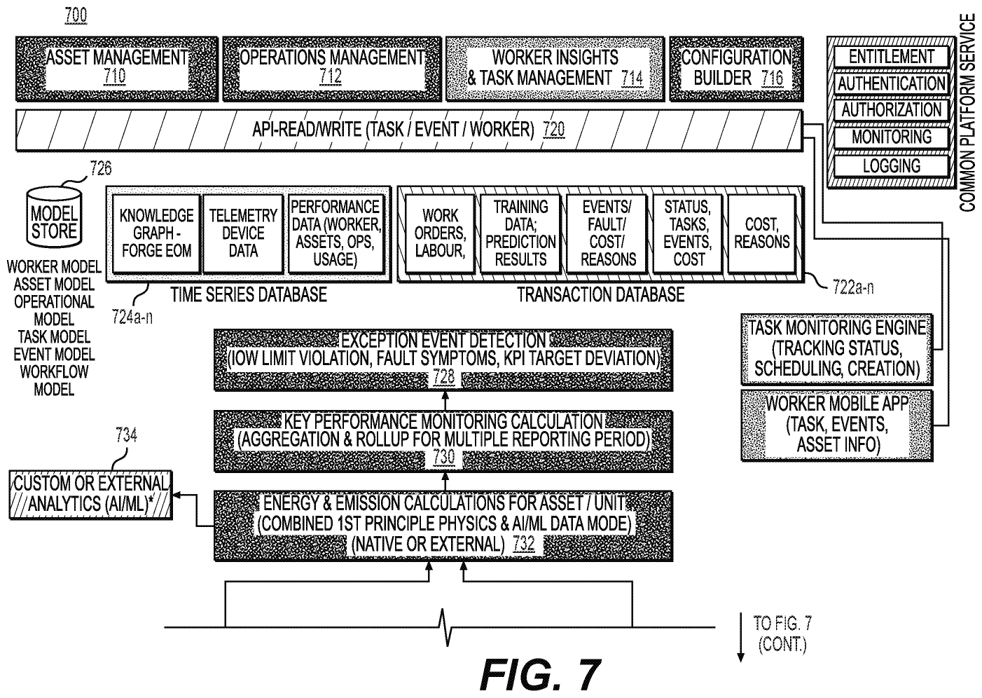

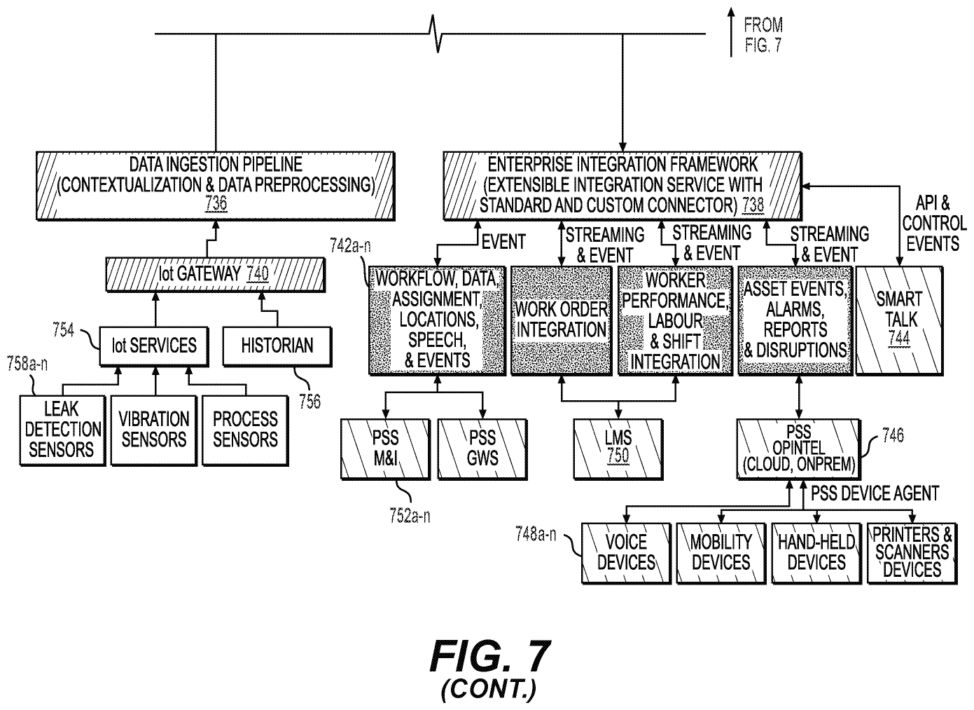

FIG. 7 depicts a schematic block diagram of a framework of a platform of a connected warehouse system 700. System 700 can include an asset management system 710, operations management system 712, worker insights and task management system 714, and configuration builder system 716. Each of systems 710, 712, 714, and 716 can be in communication with API 720, whereby API 720 can be configured to read/write tasks, events, and otherwise coordinate working with workers of system 700. API 720 can include a task monitoring engine configured to track status, schedule, and facilitate task creation. API 720 can present or otherwise be accessed via a worker mobile application (e.g., a graphical user interview on a computing device) to similarly present and manage operations related to tasks, events, and asset information.

API 720 can be communication with model store 726 whereby model store 726 can include models such as worker models, asset models, operational models, task models, event models, workflow models, and the like. API 720 can be communication with time series databases 724a-n and transaction databases 722a-n. Time series databases 724a-n can include knowledge databases, graph databases, as well as extensible object models (EOMs). Transaction databases 722a-n can include components and/or modules for work orders, labor, training data, prediction results, events, fault, costs, reasons, status, tasks, events, and reasons.

Each of databases 724a-n, 722a-n can be in communication with analytics model 734, which can be a machine learning model to effectively process, analyze, and classify operations of system 700. Model 734 can be a trained machine learning system having been trained using a learned set of parameters to predict one or more learned performance parameters of system 700. Learned parameters can include but are not limited to predictive asset maintenance of a connected warehouse, asset health management, asset maintenance optimization, worker downtime reporter, instrument asset management, vertical specific extension, and worker performance. One or more corrective actions can be taken in response to predictions rendered by model 734. Model 734 can be trained with a regression loss (e.g., mean squared error loss, Huber loss, etc.) and for binary index values it may be trained with a classification loss (e.g., hinge, log loss, etc.). Machine learning systems that may be trained include, but are not limited to convolutional neural network (CNN) trained directly with the appropriate loss function, CNN with layers with the appropriate loss function, capsule network with the appropriate loss function, Transformer network with the appropriate loss function, Multiple instance learning with a CNN (for a binary resistance index value), multiple instance regression with a CNN (for a continuous resistance index value), etc.

In certain aspects, databases 724a-n and 722a-n can operate together to perform exception event detection 728. Exception event detection 728 can utilize data from one or more data sources to detect low limit violations, fault symptoms, KPI target deviations, etc. In certain aspects of exception event detection 728, a data ingestion pipeline 736 and enterprise integration framework 738 can exchange information for energy and emission calculations per asset/units of system 700. Pipeline 736 can utilize contextual data and data preprocessing while framework 738 can include extensible integration service with standard and customer connectors.

In certain aspects, an IoT gateway 740 can be communicatively coupled to pipeline 736. IoT gateway 740 can be communicatively coupled to IoT devices 754 such as sensors 758a-n, including leak detection sensors, vibration sensors, process sensors, and/or the like. IoT gateway 740 can also be in communication with data historian 756 including historical data related to the warehouse.

Framework 738 can be in communication with event manager modules 742a-n, including workflow module, work order integration module, worker performance module, asset event module, and the like. For events, the workflow module can be configured to bidirectionally communicate with framework 738 and components of process workflow data 752a-n, including Process Safety Suite (PSS) maintenance and inspection (M&I) and PSS GWS. For event streaming, work order integration module and worker performance module can both be configured to bidirectionally communicate with framework 738 and labor management systems (LMS) 750. In some aspects, for event streaming asset event module can also be configured to bidirectionally communicate with PSS operational intelligence systems 746 and framework 738. PSS operational intelligence systems 746 in turn can be cloud-based and/or on premises and be in bidirectional communication with devices 748a-n, including voice devices, mobility devices, hand-held devices, printers, scanners, and/or the like. Framework 738 can also be in communication with start talk module 744 for corresponding API and event control.

In aspects of system 700, pipeline 736 and framework 738 work together to perform step 732 to calculate energy and emission calculations for assets and/or associated units. Model 734 can be used in performing step 732 as well as other native and/or external models connected therewith, whereby step 732 can utilize data received from pipeline 736 and framework 738.

Upon completing step 732, key performance monitoring calculations can be performed in step 730. Step 730 can be performed based on energy and emission calculations from step 732 by aggregating and rollup across one or multiple reporting periods. Upon performing step 730, the aforementioned event exception detection step 728 can be performed to detect exception events. In some aspects, step 728 can be performed based on the key performance monitoring calculations of step 730.

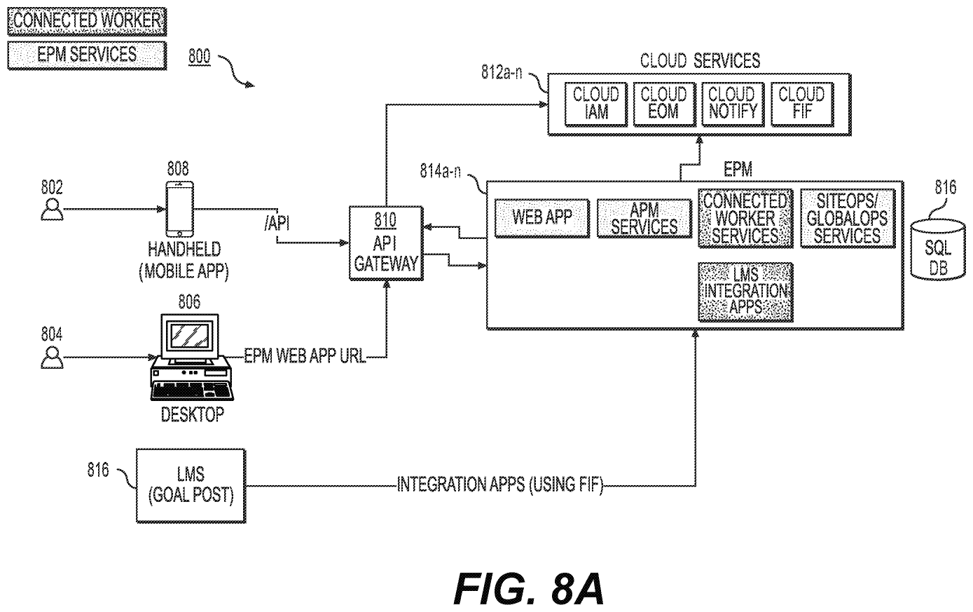

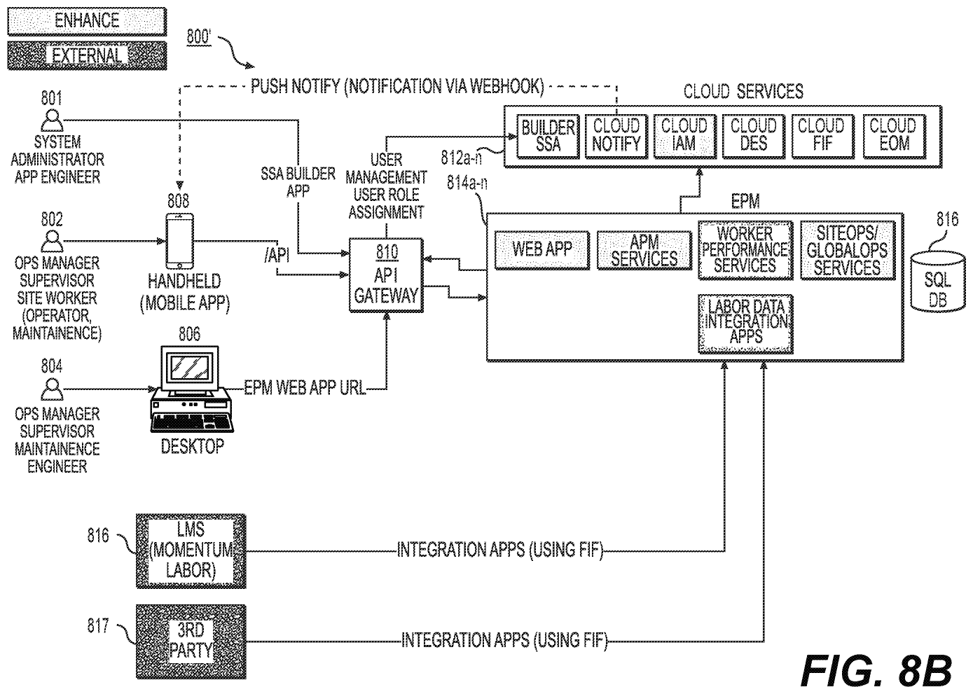

FIG. 8A is a diagram of data flow 800 of a connected warehouse system, including one with connective workers and performance management (EPM) service systems. In step 804, an operator and/or engineer may use a computing device 806 to manage system performance through a user interface (e.g., a web-based or browser-based application) using system gateway 810, which can be a cloud based. In step 802, a user (e.g., worker, manager, and/or the like) may use an app in a computing device 808 (e.g., mobile device such as a tablet or smart phone or any personal computing device) via an API to communicate and exchange data with gateway 810.

Warehouse system services 812a-n can be configured in communication with gateway 810 (e.g., receive data from gateway 810 from steps 802 and 804). Services 812a-n can be configurable to communicate and/or update in real-time functions such as identify and access management (IAM), system extensible object model (EOM), notifications, fire and gas instrumented function (FIF), etc. Performance management system 814a-n can be configured to transmit data to warehouse system services 812a-n while receiving data from LMS 816. Based on said data from LMS 816, real-time adjustments can be determined for a labor management plan associated with the warehouse and/or workers. In some aspects, the labor management plan can be updated by system 814a-n being in bidirectional communication with gateway 810. System 814a-n can include or otherwise be in communication with corresponding web apps, asset performance management (APM) services, connected worker services, LMS integration applications, site operation services, and global operation services. System 814a-n can be connected to one or more cloud-based databases (e.g., SQL DB 816). One or more components of system 814a-n can be part of computing devices and/or sensors associated with workers connected to the system.

LMS 816 can be configured to control labor costs, track performance, and predict one or more parameters associated with performance (e.g., project fulfillment execution) and transmit and/or otherwise present such information in LMS system integration applications (e.g., using FIF). In turn, system 814a-n can configured to consume data from LMS 816, gateway 810, devices 808 and 806, and services 812a-n to deliver one or more inferences to end users (e.g., one or more actions that the end-user can take or a corresponding employee or employees associated with one or more tasks) to result in changing a warehouse operation, such as warehouse operation savings. Warehouse operation savings can be directed towards safety, maintenance, performance, resource conservation, deliverable management, inventory management, etc.). An actionable update (e.g., a sync) may then be made to data flow 800.

FIG. 8B is a diagram of data flow 800′ of a connected warehouse system. In addition to previous steps 802 and 804, data flow 800′ provides step 801 in which a system administrator and/or application engineer may manage system performance through a user interface (e.g., a web-based or browser-based application) using system gateway 810, which can be a cloud based. In data flow 800′, one or more services of services 812a-n (e.g., such as the notifications module) can push messages or otherwise push notify (e.g., notification via webhook) from services 812a-n to device 808. In some aspects, data flow 800′ provides that performance management system 814a-n can receive data from LMS 816 and one or more third party systems 817. Based on said data from LMS 816 and one or more third party systems 817, real-time adjustments can be determined for a labor management plan associated with the warehouse and/or workers. In some aspects of data flow 800′, the labor management plan can be updated by system 814a-n being in bidirectional communication with gateway 810.

Aspects of FIGS. 1-8B are advantageous for measuring worker assignment/task progress in contextually relevant dimensions, visualize in real-time, and alert users (e.g., supervisor(s) and/or stakeholder(s)) upon identified anomalous trend deviations from rates of worker KPIs.

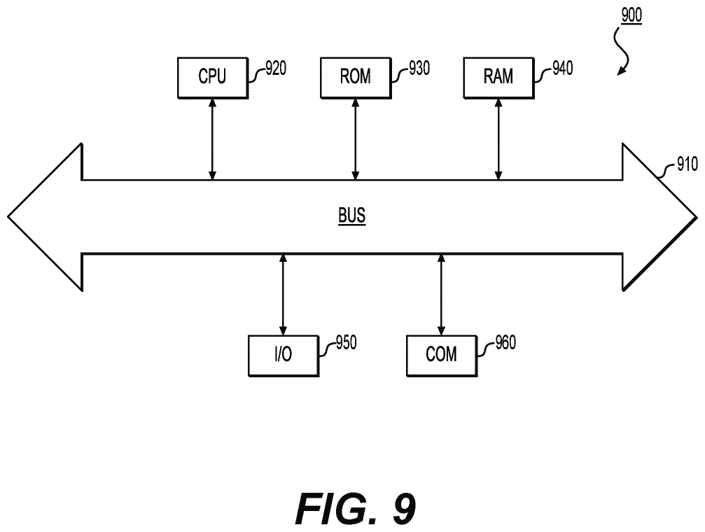

Various embodiments of the present disclosure (e.g., edge systems, gateway systems, operations centers, remote systems, warehouse systems, connected worker systems, etc.), as described above with reference to FIGS. 1-8B may be implemented using device 900 in FIG. 9. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 9, device 900 may include a central processing unit (CPU) 920. CPU 920 may be any type of processor device including, for example, any type of special purpose or a general purpose microprocessor device. As will be appreciated by persons skilled in the relevant art, CPU 920 also may be a single processor in a multi-core/multiprocessor system, such system operating alone, or in a cluster of computing devices operating in a cluster or server farm. CPU 920 may be connected to a data communication infrastructure 910, for example, a bus, message queue, network, or multi-core message-passing scheme.

Device 900 may also include a main memory 940, for example, random access memory (RAM), and may also include a secondary memory 930. Secondary memory 930, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 930 may include other similar means for allowing computer programs or other instructions to be loaded into device 900. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 900.

Device 900 may also include a communications interface (“COM”) 960. Communications interface 960 allows software and data to be transferred between device 900 and external devices. Communications interface 960 may include a modem, a network interface (such as an Ethernet card), a communications port, a PCMCIA slot and card, or the like. Software and data transferred via communications interface 960 may be in the form of signals, which may be electronic, electromagnetic, optical, or other signals capable of being received by communications interface 960. These signals may be provided to communications interface 960 via a communications path of device 900, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 900 also may include input and output ports 950 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems and methods of this disclosure can be cloud-based, multi-tenant solutions configured to deliver optimized work instructions tailored for specific vertical workflows utilizing an easy to deploy, scalable, and configurable data model and software suite to deliver performance insights and improve worker productivity.

The disclosure provides one or more user interface systems for smart worker performance scoring and evaluation of a job site (e.g., one or more warehouses), whereby information from sensors and/or connected worker computing devices may provide dynamic data about job performance (e.g., productivity of worker(s), task productivity, production productivity, etc.), a processor and database(s) for receiving and processing the dynamic data, and having a program that aggregates and analyzes the dynamic data for one or more categories of the one or more worker performance. The data analysis may determine performance scores for each of the one or more performance categories, and calculate an overall worker performance score. The worker performance score for each category of this disclosure may be displayed on a dashboard and/or related scorecards. In some aspects, one or more functions are used to calculate scores (e.g., assigning a coefficient factor to values of categories such as time on task, time between tasks, number of tasks completed, idle state, etc.). The coefficient factor may be determined from a comparison value based on some predetermined standard and/or worker performance historical data of the one or more categories. Any of the herein disclosed dashboards and related user interfaces may present worker performance scores and related details of the dynamic data for detecting and solving worker performance issues (e.g., recommended corrective actions) without changing the dashboard or the monitor.

The worker performance scores of this disclosure can include numerous scores and sub-scores, including performance scores, environmental scores related to the job site and/or areas of a job site (e.g., utility consumption, carbon footprint, emissions, etc.), health scores, safety scores, maintenance scores, job site asset scores, happiness scores, etc. Such scores are also advantageous for use in using trained machine learning models to predict performance impacts depending on trends of all such scores of this disclosure.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for centralized operations management for a plurality of sites, the method comprising:
configuring a first site management controller of a first site of the plurality of sites, the first site including a plurality of first site tools controlled by the first site management controller to:
provide first site application program interfaces (APIs) to the first site to obtain data from the plurality of first site tools;
obtain first site data from the first site APIs;
translate the first site data from the first site APIs to a specified API; and
export the first site data to a user device; and
configuring a second site management controller of a second site of the plurality of sites, the second site including a plurality of second site tools controlled by the second site management controller to:
provide second site APIs to the second site to obtain data from the plurality of second site tools;
obtain second site data from the second site APIs;
translate the second site data from the second site APIs to the specified API; and
export the second site data to the user device;
wherein the first and second APIs are selected such that the first site data and the second site data are converted to a format compatible with the same specified API.

2. The method of claim 1, further comprising:
configuring a third site management controller of a third site of the plurality of sites, the third site including a plurality of third site tools controlled by the third site management controller to:
provide third site APIs to the third site to obtain data from the plurality of third site tools;
obtain third site data from the third site APIs;
translate the third site data from the third site APIs to the specified API; and
export the third site data to the user device;
wherein the third APIs are selected such that the third site data is converted to a format compatible with the same specified API as the first site data and the second site data.

3. The method of claim 1, wherein the first site data includes operational metrics of the first site and the second site data includes operational metrics of the second site, and the method further comprises generating a first site score for the first site and a second site score for the second site.

4. The method of claim 3, further comprising generating a site score for each of the plurality of sites, aggregating the site scores of the plurality of sites to provide a normalized benchmark score that is based on an average of the site scores of each of the plurality of sites.

5. The method of claim 4, wherein the user device is configured to display the site score of each of the plurality of sites.

6. The method of claim 4, wherein the operational metrics include performance indicators based on operations, events, and/or tasks.

7. The method of claim 6, wherein the operational metrics of each of the plurality of sites is measured based on a worker at each of the plurality of sites, a team at each of the plurality of sites, and/or an area of each of the plurality of sites.

8. A computer system for centralized operations management for a plurality of sites, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
configuring a first site management controller of a first site of the plurality of sites, the first site including a plurality of first site tools controlled by the first site management controller to:
provide first site application program interfaces (APIs) to the first site to obtain data from the plurality of first site tools;
obtain first site data from the first site APIs;
translate the first site data from the first site APIs to a specified API; and
export the first site data to a user device; and
configuring a second site management controller of a second site of the plurality of sites, the second site including a plurality of second site tools controlled by the second site management controller to:
provide second site APIs to the second site to obtain data from the plurality of second site tools;
obtain second site data from the second site APIs;
translate the second site data from the second site APIs to the specified API; and
export the second site data to the user device;
wherein the first and second APIs are selected such that the first site data and the second site data are converted to a format compatible with the same specified API.

9. The system of claim 8, further comprising functions for:
configuring a third site management controller of a third site of the plurality of sites, the third site including a plurality of third site tools controlled by the third site management controller to:
provide third site APIs to the third site to obtain data from the plurality of third site tools;
obtain third site data from the third site APIs;
translate the third site data from the third site APIs to the specified API; and
export the third site data to the user device;
wherein the third APIs are selected such that the third site data is converted to a format compatible with the same specified API as the first site data and the second site data.

10. The system of claim 8, wherein the first site data includes operational metrics of the first site and the second site data includes operational metrics of the second site, and the method further comprises generating a first site score for the first site and a second site score for the second site.

11. The system of claim 10, further comprising generating a site score for each of the plurality of sites, aggregating the site scores of the plurality of sites to provide a normalized benchmark score that is based on an average of the site scores of each of the plurality of sites.

12. The system of claim 11, wherein the user device is configured to display the site score of each of the plurality of sites.

13. The system of claim 11, wherein the operational metrics include performance indicators based on operations, events, and/or tasks.

14. The system of claim 13, wherein the operational metrics of each of the plurality of sites is measured based on a worker at each of the plurality of sites, a team at each of the plurality of sites, and/or an area of each of the plurality of sites.

15. A non-transitory computer-readable medium containing instructions for centralized operations management for a plurality of sites, the instructions comprising:
configuring a first site management controller of a first site of the plurality of sites, the first site including a plurality of first site tools controlled by the first site management controller to:
provide first site application program interfaces (APIs) to the first site to obtain data from the plurality of first site tools;
obtain first site data from the first site APIs;
translate the first site data from the first site APIs to a specified API; and
export the first site data to a user device; and
configuring a second site management controller of a second site of the plurality of sites, the second site including a plurality of second site tools controlled by the second site management controller to:
provide second site APIs to the second site to obtain data from the plurality of second site tools;
obtain second site data from the second site APIs;
translate the second site data from the second site APIs to the specified API; and
export the second site data to the user device;
wherein the first and second APIs are selected such that the first site data and the second site data are converted to a format compatible with the same specified API.

16. The non-transitory computer-readable medium of claim 15, further comprising instructions for:
configuring a third site management controller of a third site of the plurality of sites, the third site including a plurality of third site tools controlled by the third site management controller to:
provide third site APIs to the third site to obtain data from the plurality of third site tools;
obtain third site data from the third site APIs;
translate the third site data from the third site APIs to the specified API; and
export the third site data to the user device;
wherein the third APIs are selected such that the third site data is converted to a format compatible with the same specified API as the first site data and the second site data.

17. The non-transitory computer-readable medium of claim 15, wherein the first site data includes operational metrics of the first site and the second site data includes operational metrics of the second site, and the method further comprises generating a first site score for the first site and a second site score for the second site.

18. The non-transitory computer-readable medium of claim 17, further comprising instructions for generating a site score for each of the plurality of sites, aggregating the site scores of the plurality of sites to provide a normalized benchmark score that is based on an average of the site scores of each of the plurality of sites.

19. The non-transitory computer-readable medium of claim 18, wherein the user device is configured to display the site score of each of the plurality of sites.

20. The non-transitory computer-readable medium of claim 18, wherein the operational metrics include performance indicators based on operations, events, and/or tasks.
